(19) United States
(12) Patent Application Publication
(10) Pub. No.: US 2005/0210741 A1
(43) Pub. Date: Sep. 29, 2005

(54) Disposable paper vase

(76) Inventor: Troy Joern Feddern, Adelaide (AU)

Correspondence Address: TROY FEDDERN, 17 DEW STREET, ABERFOYLE PARK, 5159, AU

(21) Appl. No.: 11/122,128

(22) Filed: May 5, 2005

(30) Foreign Application Priority Data
Oct. 28, 2003 (AU) 2003100887

(51) Int. Cl. A01G 5/00

(52) U.S. Cl. 47/41.01

(57) ABSTRACT

The disposable vase is an in expensive way to display cut flowers bought as a bunch or a bouquet which can sit inside a wax proofed vase and then when the bunch has died the vase can be tossed out with the flowers. 1) The vase is essentially composed of 2 parts an inner waxed cup and a cone shaped outer cover. 2) The outer cover is made of thick u shaped card that is scrolled into a circle and sealed or held together with a double sided adhesive tape. 3) The U shaped cardboard when scrolled and sealed by the tape form effective a cone shape, this can be described as an ice-cream cone, turned upside down and then the base of the ice-cream cone is cut off. 4) The cone is open at the top and the bottom the larger opening on the cone sit firmly on a table surface. The small opening, which is the top, is open for the paper cup, which is waxed to be inserted. 5) With the waxed paper cup inserted into the top of the cone it now becomes a snug fit and the cone cannot topple over. 6) Water is then inserted into the paper-waxed cup, which sits inside the cone. The water helps to weight the whole vase down and also prevents the cone from toppling over. 7) Flowers are then inserted into the paper cup and can sit safely for the life of the flowers without the vase falling over, falling apart or leaking. 8) The waxed paper cup will retain water for up to six months or more if need be. 9) The waxed paper cup is the same style of cup used in most fats food outlets for soda or thick shakes. 10) The inventiveness of the product is that the wax cup on itself can act as a vase but because its base is smaller than its top flowers will topple over all the time With a cone attached to the cup the cone gives stability to the cup and it will never fall over even being knocked. 11) The vase will be assembled and sold as a complete unit so the wholesaler or retailer will not have to construct the vase him or herself.

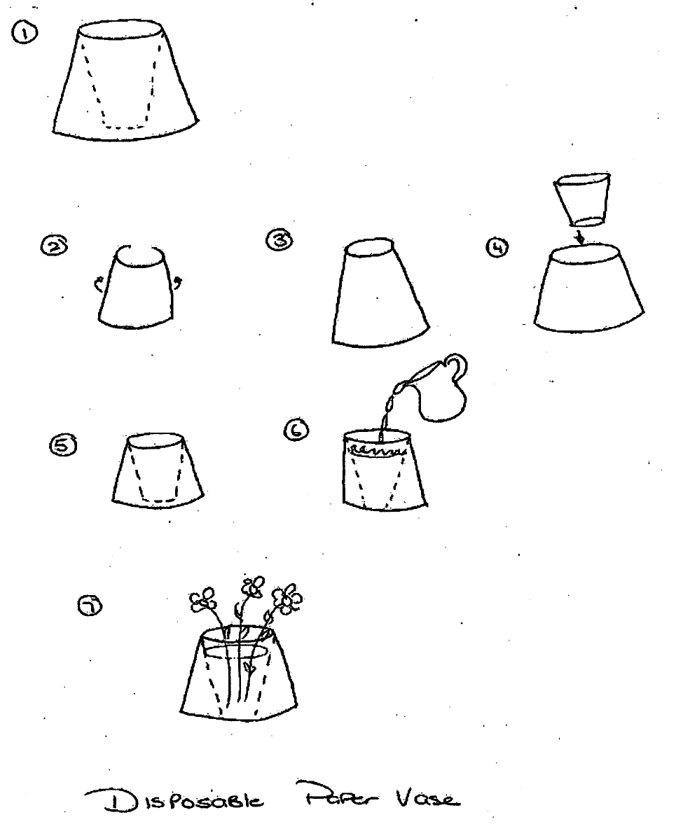

This Patent application for the invention of a disposable paper vase.

The florist industry is large and numerous people buy bunches or bouquets of flowers for their homes, friends or celebrations.

Often they take flowers to the hospital and are left with nothing to put the flowers in for patients when they arrive.

I have seen numerous jam jars that are used instead for a vase which take away from the aesthetic value of the flowers.

Florist is forced to use expensive vases of glass or ceramics when selling flowers to people or they use the plastic florist supply trays to organise arrangements.

The disposable vase is an in expensive way to display cut flowers bought as a bunch or a bouquet which can sit inside a wax proofed vase and then when the bunch has died the vase can be tossed out with the flowers.

1. The vase is essentially composed of 2 parts an inner Plasticor paper cup and a cone shaped outer cover.

2. The outer cover is made of thick u shaped card that is scrolled into a circle and sealed or held together with a double sided adhesive tape
1) The u shaped cardboard when scrolled and sealed by the tape form effective a cone shape, this can be described as an ice-cream cone, turned upside down and then the base of the ice-cream cone is cut off.

3. The cone is open at the top and the bottom the larger opening on the cone sits firmly on a table surface. The small opening, which is the top, is open for the plastic or paper cup, which is waxed to be inserted.

4. With the Plastic or paper cup inserted into the top of the cone it now becomes a snug fit and the cone cannot topple over.

5. Water is then inserted into the Plastic or paper cup, which sits inside the cone. The water helps to weight the whole vase down and also prevents the cone from toppling over
2) Flowers are then inserted into the plastic or paper cup and can sit safely for the life of the flowers without the vase falling over, falling apart or leaking.

6. The Plastic or paper cup will retain water for up to six months or more if need be
3) The Plastic or paper cup is the same style of cup used in most fast food outlets for soda or thick shakes.

7. The inventiveness of the product is that the cup on itself can act as a vase but because its base is smaller than its top flowers will topple over all the time
With a cone attached to the cup the cone gives stability to the cup and it will never fall over even being knocked.

8. The vase will be assembled and sold as a complete unit so the wholesaler or retailer will not have to construct the vase him or herself.
